(19) United States
(12) Patent Application Publication
(10) Pub. No.: US 2007/0057813 A1
(43) Pub. Date: Mar. 15, 2007

(54) RF meter reading network with wake-up tone calibrated endpoints

(76) Inventors: Barry Cahill-O'Brien, Spokane, WA (US); Mark K. Cornwall, Spokane, WA (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/222,682

(22) Filed: Sep. 9, 2005

(51) Int. Cl. G08C 15/06

(52) U.S. Cl. 340/870.02

(57) ABSTRACT

The radio frequency meter reading network of the present invention generally includes a utility meter, an endpoint interfaced to that utility meter and a reading device. The endpoint includes a receiver/transmitter having an oscillator and a data collector. The reading device operates to transmit a wake-up tone. The receiver of the endpoint scans frequencies looking for the wake-up tone and upon receiving it, utilizes the information contained within the wake-up tone transmission to calibrate its oscillator and transmit the utility meter data collected by the data collector.

### FIELD OF THE INVENTION

The present invention relates to radio frequency (RF) meter reading networks and, more particularly, to the calibration of the oscillator of an endpoint, within the meter reading network, to an RF wake-up tone.

### BACKGROUND OF THE INVENTION

A radio network for meter reading traditionally consists of a series of low cost data collectors or endpoints, fitted to utility meters. These endpoints are wirelessly linked to a reading device, and send the data collected at the meter to the reading device. From the reading device, the data is forwarded to a central billing processor, where it is used to generate the customer bill.

The wireless link usually uses a radio frequency medium (RF) to send this data from the collector to the reader because RF performs well in many environments. Whenever data is sent using RF energy, the designer needs to be aware of the constraints of this medium, especially with regards to: (1) the legal regulations, which govern the spectrum in which the designer wants to operate; (2) the potential for interference and corruption of the signal traveling through the air; (3) the need to match the transmitter and receiver frequencies to optimize the transfer of data; and (4) the need to maintain low cost.

### SUMMARY OF THE INVENTION

The constraints described above are in large part addressed by the meter reading network of the present invention. The radio frequency meter reading network of the present invention generally includes a utility meter, an endpoint interfaced to that utility meter and a reading device. The endpoint includes a receiver/transmitter having an oscillator and a data collector. The reading device operates to transmit a wake-up tone. The receiver of the endpoint scans frequencies looking for the wake-up tone and upon receiving it, utilizes the information contained within the wake-up tone transmission to calibrate its oscillator and transmit the utility meter data collected by the data collector.

### BRIEF DESCRIPTION OF THE DRAWINGS

FIG. 1 depicts a radio-based automatic meter reading system of the present invention.

### DETAILED DESCRIPTION OF THE PREFERRED EMBODIMENTS

The present invention relies on a low cost meter reading module to be capable of acquiring a known RF signal and then adjusting its internal reference oscillator to eliminate errors in its frequency. The presence of this known RF signal also dictates when and how the meter reading module should transmit its data and, therefore, prevent unwanted RF transmissions. The system of the present invention balances the cost of the system with the battery life to achieve very good range performance and throughput.

In conjunction with the detailed description provided below, this application hereby incorporates by reference commonly assigned U.S. Provisional Application No. 60/500,507 (Attorney Docket No. 1725.173US01), filed on Sep. 5, 2003, entitled, “SYSTEM AND METHOD FOR DETECTION OF SPECIFIC ON-AIR DATA RATE,” U.S. Provisional Application No. 60/500,515 (Attorney Docket No. 1725.162US01), filed Sep. 5, 2003, entitled, “SYSTEM AND METHOD FOR MOBILE DEMAND RESET,” U.S. Provisional Application No. 60/500,504 (Attorney Docket No. 1725.160US01), filed Sep. 5, 2003, entitled, “SYSTEM AND METHOD FOR OPTIMIZING CONTIGUOUS CHANNEL OPERATION WITH CELLULAR REUSE,” U.S. Provisional Application No. 60/500,479 (Attorney Docket No. 1725.156US01), filed Sep. 5, 2003, entitled, “SYNCHRONOUS DATA RECOVERY SYSTEM,” U.S. Provisional Application No. 60/500,550 (Attorney Docket No. 1725.161US01), filed Sep. 5, 2003, entitled, “DATA COMMUNICATION PROTOCOL IN AN AUTOMATIC METER READING SYSTEM,” U.S. patent application Ser. No. 10/655,760 (Attorney Docket No. 10145-8011.US00), filed on Sep. 5, 2003, entitled, “SYNCHRONIZING AND CONTROLLING SOFTWARE DOWNLOADS, SUCH AS FOR COMPONENTS OF A UTILITY METER-READING SYSTEM,” and U.S. patent application Ser. No. 10/655,759, (Attorney Docket No. 10145-8012.US00) filed on Sep. 5, 2003, entitled, “FIELD DATA COLLECTION AND PROCESSING SYSTEM, SUCH AS FOR ELECTRIC, GAS, AND WATER UTILITY DATA.”

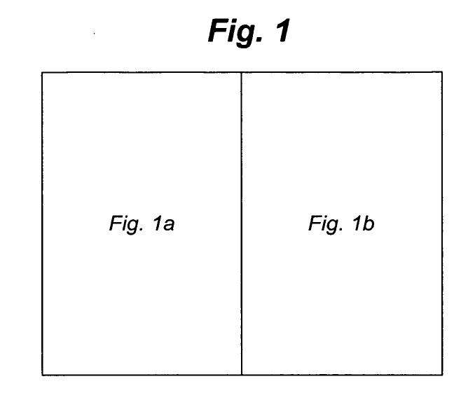

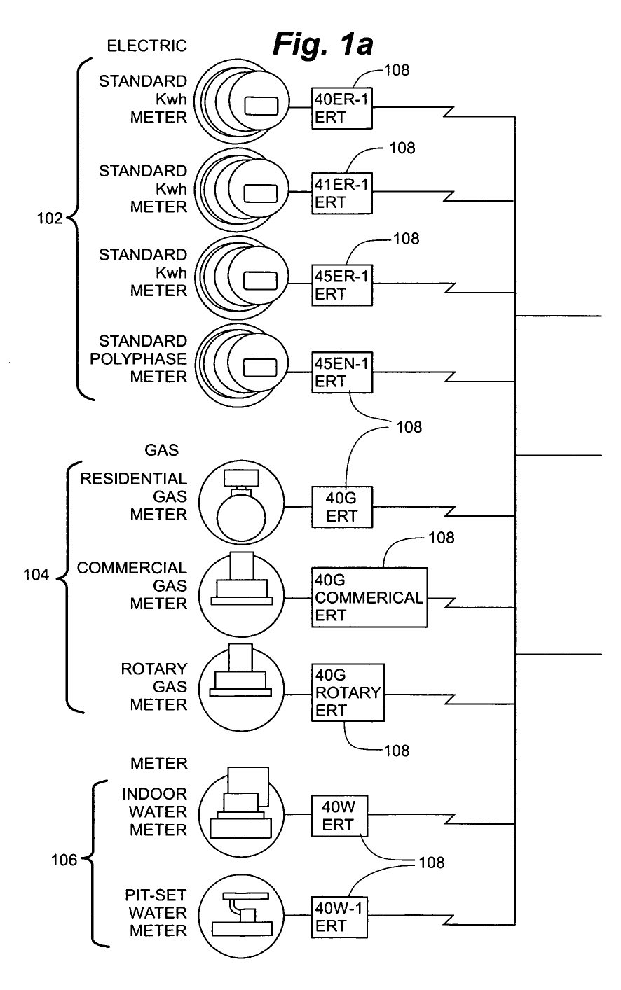

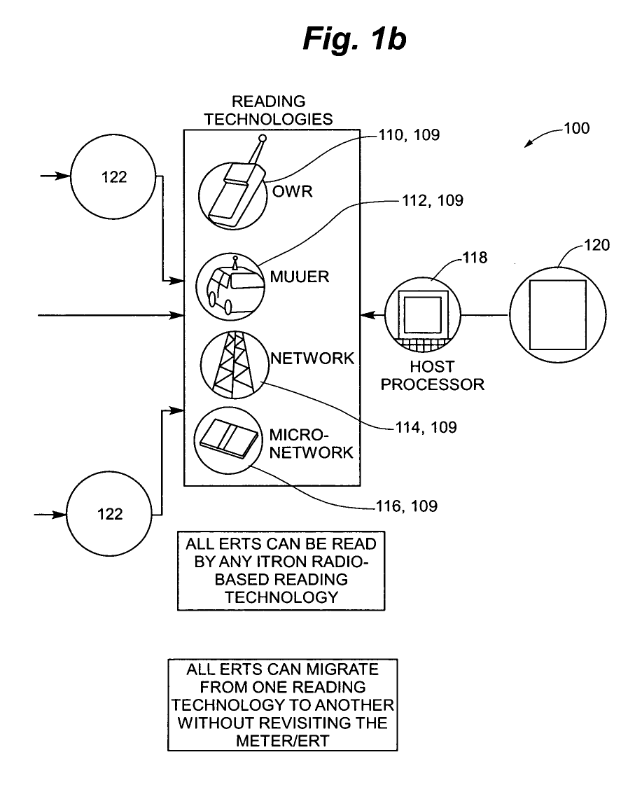

In an automatic meter reading system 100 of the present invention, as depicted in FIG. 1, the components generally include a plurality of telemetry devices including, but not limited to, electric meters 102, gas meters 104 and water meters 106. Each of the meters may be either electrically or battery powered. The system further includes a plurality of endpoints 108, wherein each corresponds and interfaces to a meter. Each of the endpoints 108 preferably incorporates a radio receiver/transmitter, e.g., the Itron, Inc. ERT. The system additionally includes one or more readers 109 that may be fixed or mobile, FIG. 1 depicts: (1) a mobile hand-held reader 110, such as that used in the Itron Off-site meter reading system; (2) a mobile vehicle-equipped reader 112, such as that used in the Itron Mobile AMR system; (3) a fixed radio communication network 114, such as the Itron Fixed Network AMR system that utilizes the additional components of cell central control units (CCUs) and network control nodes (NCNs); and (4) a fixed micro-network system, such as the Itron MicroNetwork AMR system that utilizes both radio communication through concentrators and telephone communications through PSTN. Of course other types of readers may be used without departing from the spirit or scope of the invention. Further included in AMR system 100 is a head-end, host processor 118. The host processor incorporates software that manages the collection of metering data and facilitates the transfer of that data to a utility or supplier billing system 120.

The meter reading system of the present invention is preferably a one-way, wake-up system, in which the receiver reader 109 sends out a wake-up tone and the endpoints 108 on the meters respond to this tone by sending back their data. This system is particularly appropriate for applications where laws dictate that the transmissions occur only on specific radio channels or whereby operating on fixed channels, the performance of the system can be enhanced. The system of the present invention is applicable to high and low speed mobile reading, as well as fixed network reading.

The system of the present invention is different from other wireless systems in that the data collectors within the endpoints 108 use the wake-up tone to accurately refine their local oscillators, and then respond within the specified channel, with their data payload. By using the reference wake-up tone, the data collectors do not need to be equipped with expensive calibrated temperature stable oscillators.

A wake-up scheme (as compared to a bubble-up scheme, where the devices randomly transmit the data), as used in the present invention, has an important advantage in that the reader can target only devices within a certain range, or type, and so prevent excessive amounts of traffic. This is especially important when higher power transmitters are used. The system of the present invention is also inherently quiet, and communicates only when a reader is in the area. This “good neighbor” policy is important when the band is shared amongst many users.

In normal operation, the endpoints 108 operate in a receive-only scheme, where they collect data from the meter, and check on a periodic basis for the presence of the wake-up tone. Since these receivers within the endpoint have not locked to a specific frequency, they may have to scan for a carrier, however, since the carrier preferably transmits a known symbol, it is possible to determine if there is a carrier present. If there is no carrier of the specified type present, the collector goes back to collecting.

However, in the presence of the carrier with the correct symbol, the endpoint 108 can look at the symbol to determine the frequency of the carrier, and the type of transmission required.

The endpoint 108 uses the information in the symbol to calibrate its local oscillator to match the wake-up tone. In addition, by looking at the symbol, the endpoint recognizes the type of reader device.

If the reader device is a hand-held device, indicating that the reader device is moving slowly, it will use a single response channel, which the reader has set its receiver at (based on the wake-tone channel). This allows for a full duplex response. The data collector at the endpoint performs carrier sensing to prevent collisions, and may send multiple transmissions, to assist in delivery.

If the reader device is a vehicle moving quickly, the data collector assumes a multi-channel receiver and sends its response on the next available channel. The data collector may retry on multiple channels, and then go quiet to allow other devices to operate.

If the reader device is a repeater or fixed network reader, it may send a processing gain enhanced packet to compensate for multi-path and fading.

By using the above approach, wherein the data collectors of the endpoints 108 refine their local oscillators to the wake-up tone, the costs associated with precise stable reference oscillators in the data collector are eliminated. The sensitivity of the system can be optimized, and the endpoints 108 are not excessively noisy.

The present invention may be embodied in other specific forms without departing from the spirit of the essential attributes thereof; therefore, the illustrated embodiments should be considered in all respects as illustrative and not restrictive, reference being made to the appended claims rather than to the foregoing description to indicate the scope of the invention.

What is claimed:

1. A radio frequency (RF) meter reading network, comprising:
a utility meter;
an endpoint interfaced to said utility meter, wherein said endpoint includes a receiver/transmitter having an oscillator and data collector;
a reading device, wherein said reading device transmits a wake-up tone, wherein said receiver/transmitter receives said wake-up tone and utilizes information contained within said wake-up tone transmission to calibrate its oscillator to match the frequency of the wake-up tone.

2. The RF meter reading network of claim 1, wherein said wake-up tone comprises a carrier containing a known symbol.

3. The RF meter reading network of claim 2, wherein said symbol indicates to the endpoint the type of reading device.

4. The RF meter reading device of claim 3, wherein said reading device is selected from the group consisting of: a handheld terminal; a vehicle, a repeater, and a fixed network reader.

5. The RF meter reading device of claim 1, wherein said reading device is selected from the group consisting of: a handheld terminal; a vehicle, a repeater, and a fixed network reader.

6. The RF meter reading device of claim 4, wherein said endpoint transmits collected utility meter data in a manner consistent with the type of reading device transmitting said wake-up tone.

7. The RF meter reading device of claim 6, wherein said manner is selected from a single channel response for a handheld reading device and a multi-channel response for a vehicle reading device.

8. A method for transmitting data in an RF meter reading network, wherein said network includes a utility meter, an endpoint interfaced to said utility meter, wherein said endpoint includes a receiver/transmitter having an oscillator and a data collector, and a reading device, the method comprising the steps of:
transmitting a wake-up tone from said reading device;
receiving the wake-up tone with said receiver/transmitter calibrating the frequency of the oscillator according to the received wake-up tone transmission; and
transmitting to said reading device, via the calibrated oscillator of said receiver/transmitter, data collected by said data collector from said utility meter.

9. The method of claim 8, wherein said wake-up tone comprises a carrier containing a known symbol.

10. The method of claim 9, wherein said symbol indicates to the endpoint the type of reading device.

11. The method of claim 10, wherein said reading device is selected from a the group consisting of: a handheld terminal, a vehicle, a repeater, and fixed network reader.

12. The method of claim 8, wherein said reading device is selected from a the group consisting of: a handheld terminal, a vehicle, a repeater, and fixed network reader.

13. The method of claim 11, wherein said step of transmitting is performed in a manner consistent with the type of reading device transmitting said wake-up tone.

14. The method of claim 13, wherein said manner is selected from a single channel response for a handheld reading device and a multi-channel response for a vehicle reading device.
